(19) United States
(12) Patent Application Publication
(10) Pub. No.: US 2009/0044115 A1
(43) Pub. Date: Feb. 12, 2009

(54) PREVIEWING AUDIO DATA

(76) Inventor: Jan-Hinnerk Helms, Hamburg (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/834,680

(22) Filed: Aug. 6, 2007

(51) Int. Cl. G06F 3/01

(52) U.S. Cl. 715/716

(57) ABSTRACT

A program product, a graphical user interface, a computer system including such a graphical user interface and method for previewing audio data, wherein an image is displayed which represents at least a part of an internal structure of the audio data. According to one particular implementation the image is a screenshot or part of a screenshot taken when last saving the audio data.

This application relates to previewing audio data.

### BACKGROUND

Recently, personal computers became capable of working with steadily increasing amounts of data. For example, images or video are stored with higher resolutions requiring more storage capacity and an increased computational power.

In the same course, music or video projects that in the past would have required an array of professional studio equipment, can now be completed in a home or project studio, using a personal computer and readily available resources. A personal computer with a fast processor and enough RAM can serve as a workstation for recording, arranging, mixing, and producing complete music projects, which can be played back on the computer, burnt on a CD or DVD, or distributed over the Internet. Video projects can be produced together with accompanying audio in a similar manner.

However, when accessing data like images, video or audio, usually a special program needs to be started and the complete data needs to be loaded. Such a process of starting a designated program and loading the complete data needs an amount of time which is not negligible. Accordingly, the user needs to wait before he can view or listen to a chosen resource.

Therefore, it can sometimes be annoying to wait during a program for reading a file is starting or when large amounts of data are loaded. Devices or programs for previewing image files have been proposed which display a thumbnail of an image so that the user knows which image is stored in a certain image file before he decides to open that image file.

### SUMMARY OF THE DESCRIPTION

In one aspect, a method for previewing audio data is provided. Such a method may feature operations such as displaying an image which represents at least a part of an internal structure of the audio data. Previewing is understood in the context of this document as any form of acoustic or visual representation of data. Previewing provides a quick access to get an acoustic or visual impression of at least part of the data without the need to start a program with a comparably long start time.

Certain embodiments may include one or more of the following features. The audio data may be part of a project being created by a music program for recording, arranging, mixing, and producing complete music projects. The image may be stored within a data structure of the project. Previewing audio data may include that the music program does not need to be loaded for previewing.

The image may be a screenshot or part of a screenshot taken when last saving the audio data. Such an image may comprise at least part of an arrange area and/or at least part of a track editor area.

In certain embodiments, wherein, while the image is displayed, at least part of the audio data can be reproduced during preview using an audio file designated for preview. Multiple previews with respective images of the audio data stored at different points in time may be displayed in a stacked manner and it may be possible to browse through these multiple previews.

These embodiments may be implemented using a method, a program, a program product, a user interface, a computer system, a data processing system, a consumer electronic device or any combination of such implementations.

Certain embodiments may have one or more of the following advantages. For example, an audio project, which is preferably a music project, may be previewed by listening to at least part of its music contents while watching at the same time an image which represents a part of the internal structure. Such previewing provides for a quick access to the music project without the necessity to load large amounts of data or to start a program which is suitable for recording, arranging, mixing, and producing complete music projects and therefore requires a not negligible amount of time for starting. Accordingly, at least some embodiments allow a user to get a quick impression of the content of audio data. In such an embodiment, the user does not only get an acoustic impression but also a visual impression of the audio data. The provided image may enable the user to easier recognize a special music project he had worked on.

Furthermore, at least certain embodiments provide a screenshot as the image which was taken when last saving the audio data. This may, for example, be especially advantageous, if a user worked on a music project and stored multiple versions of it which are similar in their acoustic impressions. In this case, the user may easily recognize a special version he is looking for by watching the images displayed when previewing the music projects. The user may remember what the user interface looked liked when he saved that special version. Accordingly, providing an image of a music project for previewing a music project may in certain implementations facilitate finding or recognizing a certain music project for the user.

Other aspects, features, and advantages will be apparent from the following detailed description, the drawings, and the claims.

### BRIEF DESCRIPTION OF THE DRAWINGS

The present invention is illustrated by way of example and not limitation in the of the accompanying drawings in which like references indicate similar elements.

FIG. 1 is a schematic view of a computer.

FIG. 2 is a schematic view of an embodiment of a file browser.

FIG. 3 is another schematic view of an embodiment of a file browser.

FIG. 4 is a schematic view of a screenshot of an embodiment of a music project.

FIG. 5 is an exemplary view of previewing audio data.

FIG. 6 is another exemplary view of previewing audio data.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a through understanding of various embodiments of the present invention. However, in certain instances, well-known or conventional details are not described in order to provide a concise discussion of embodiments of the present inventions.

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple Inc., 2007.

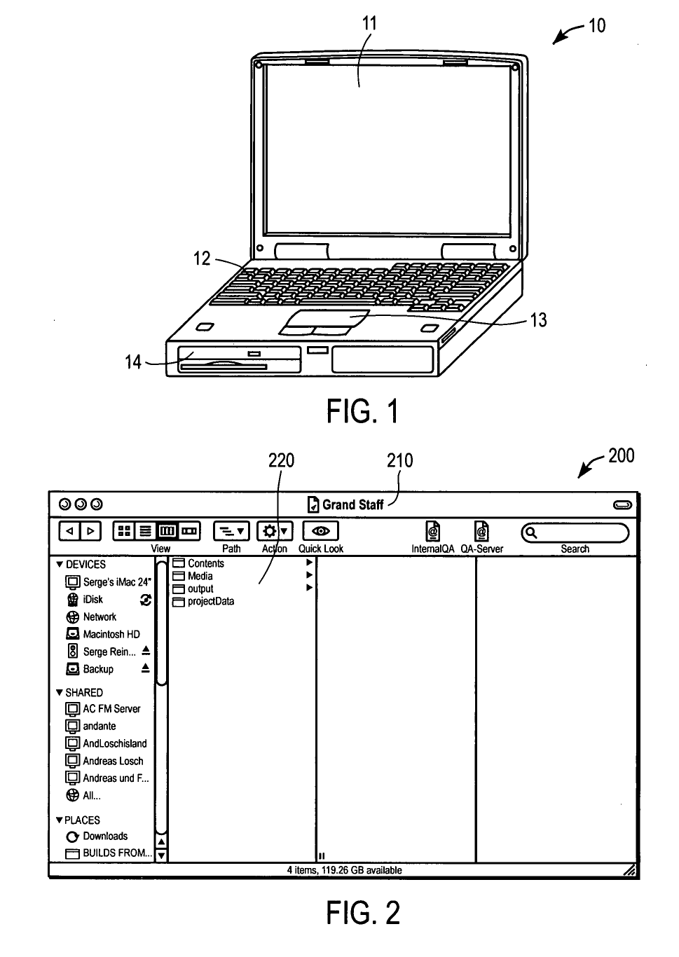

FIG. 1 illustrates a data processing system 10 such as a computer system which may include a graphical user interface which is displayed on a display device such as a screen. The computer system comprises a screen 11 which is connected to a processing system incorporating a processor and a memory such as a semiconductor memory (e.g. RAM) and/or a magnetic memory. The computer system may also include a keyboard 12, a touch pad 13 and a mouse (not shown) connected to the processing system.

The processing system 10 includes, in one embodiment, system computer software for controlling the computer system. The software also includes control of the graphical user interface. The software may be downloaded from a server through a network or stored on an optical media, such as CD-ROM 14 or stored on other machine readable media (e.g. non-volatile memory such as magnetic hard drive or flash memory).

The processing system 10 may be used for recording, arranging, mixing, and producing complete music projects, which can be played back, burnt on a CD or DVD, or distributed over the Internet.

The present invention can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CDROMs, and magneticoptical disks, readonly memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

FIG. 2B of U.S. Pat. No. 6,222,549, which is hereby incorporated herein by reference, shows one example of a data processing system, such as a computer system, which may be used with the present invention. Note that while this Figure illustrates various components of a data processing system, it is not intended to represent any particular architecture or manner of interconnecting the components as such details are not germane to the present invention. It will also be appreciated that network computers, personal digital assistants (PDAs), cellular telephones, handheld computers, special purpose computers, entertainment systems and other data processing systems and consumer electronic devices which have fewer components or perhaps more components may also be used with the present invention. The system of this Figure may, for example, be a Macintosh computer from Apple Inc.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; electrical, optical, acoustical or other form of storage systems.

It will be apparent from this description that aspects of the inventions may be embodied, at least in part, in software. That is, the techniques may be carried out in a computer system or other data processing system in response to its processor or processing system executing sequences of instructions contained in a memory, such as RAM, etc. In various embodiments, hardwired circuitry may be used in combination with the software instructions to implement the present inventions. Thus, the techniques are not limited to any specific combination of hardware circuitry and software, nor to any particular source for the instructions executed by the data processing systems.

FIG. 2 shows an example of a file browser 200 which provides views of files stored in a file system such as a hierarchical file system (HFS). Such a file browser 200 may be used to search or navigate through the contents of the data processing system 10 or any other kind of storage device. In the example shown in FIG. 2, a music project with a name 210 being “Grand Staff” has been opened. Such a music project, which may contain any kind of audio data with or without additional video or image data, may be created by a program for recording, arranging, mixing, and producing complete music projects. Such a program may organize the project data in multiple files and/or subdirectories. One possible embodiment of such an organization of project data is shown in a second column 220 of the file browser 200.

The exemplary music project “Grand Staff” contains three subdirectories with the names “Contents”, “Media” and “Output” along with a file called “projectData” as shown in the second column 220. In this embodiment, the folder “Output” is of special interest because it contains files which enable a quick and comfortable preview of the content of the music project “Grand Staff”.

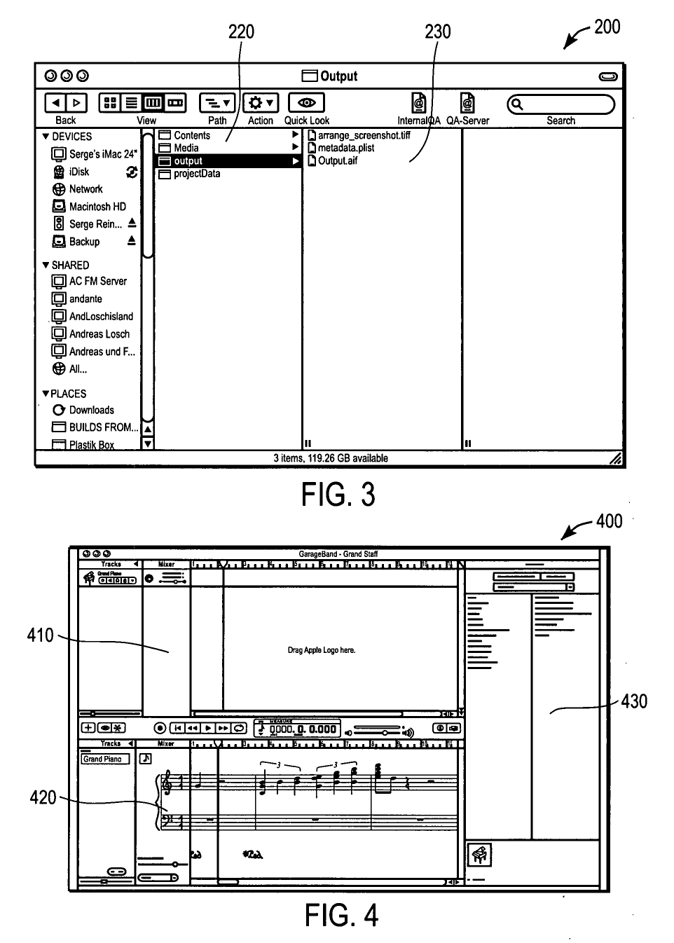

FIG. 3 provides an example of the content of the folder “Output” shown in FIG. 2. The folder “Output” has been selected in the second column 220 as is indicated by the dark background color of its line. Therefore, a third column 230 shows the content of the folder “Output”. In this specific example, it contains three files. Among those are the files named “Output.aif” and “arrange_screenshot.tiff” which are designated for previewing. The file “Output.aif” has an audio format and can easily be reproduced for previewing. The audio content of “Output.aif” may be a part of or the complete song of the music project “Grand Staff”. Reproducing or playing back a file like “Output.aif” does not require opening the associated music project. The audio file given here as an example has the file format “.aif”, however, such an audio file could be of any other known format suitable for audio data.

Without a previewing function, a program for recording, arranging, mixing, and producing complete music projects would have to be opened to access the content of the music project “Grand Staff”. After opening such a program, all the different pieces of the music project stored in the directories “Contents”, “Media” and the file “projectData” shown in the second column 220 would have to be loaded. Only thereafter, the user could playback the audio data of the music project and listen to its contents.

The third column 230 also shows the image file named “arrange_screenshot.tiff”. This file contains an image which represents at least a part of an internal structure of the audio data of the music project “Grand Staff”. The image file given here as an example has the file format “.tiff”, however, such an image file could be of any other known format suitable for image data. Image data may either be data of a still-picture or a moving-picture. The image contained in the file “arrange_screenshot.tiff” may be a screenshot or part of a screenshot preferably taken when last saving the audio data of the music project “Grand Staff”. Such an image may be displayed when previewing the music project.

In this specific embodiment, the music project “Grand Staff” can be previewed by listening to the music content of the file “Output.aif” and looking at the image of the file “arrange_screenshot.tiff”. For such a preview, it is not necessary to open a program for recording, arranging, mixing, and producing complete music projects like “GarageBand”, “Logic Pro” or the like, or to load a significant part of the music project.

FIG. 4 shows one possible example of the content of the image file representing at least a part of the internal structure of the audio data. In this particular implementation, the image file is a screenshot 400. This screenshot 400 may show a user interface of a program which can be used for the above mentioned purposes. Additional menu bars may be provided. In this assembly, the user interface lists tracks together with their audio content arrangement in a first image section 410. The example shown features one track with a piano assigned to it. The piano may be replaced by any other instrument. Further tracks with the same or other instruments or MIDI tracks may be displayed depending on the content of the music project to be previewed. The user interface of this example also features in the center an area with buttons for e.g. starting and stopping playback or recording along with other options. A second image section 420 shows a track editor. The track editor in this mode shows a notation view of the selected track. A third image section 430 shows additional track information which is in this example that the “Grand Piano” is selected as a software instrument of the currently selected track. However, it should be understood that the screenshot 400 is purely given as an example. The content and the arrangement of a screenshot taken when last saving the audio data purely depends on what the user of the program did before saving and how he arranged the music and the windows or sections of the display. Especially because of the infinite number of possible arrangements of the display, a screenshot like the one shown in FIG. 4 is a suitable means to facilitate the recognition of a music project for a user when previewing that project.

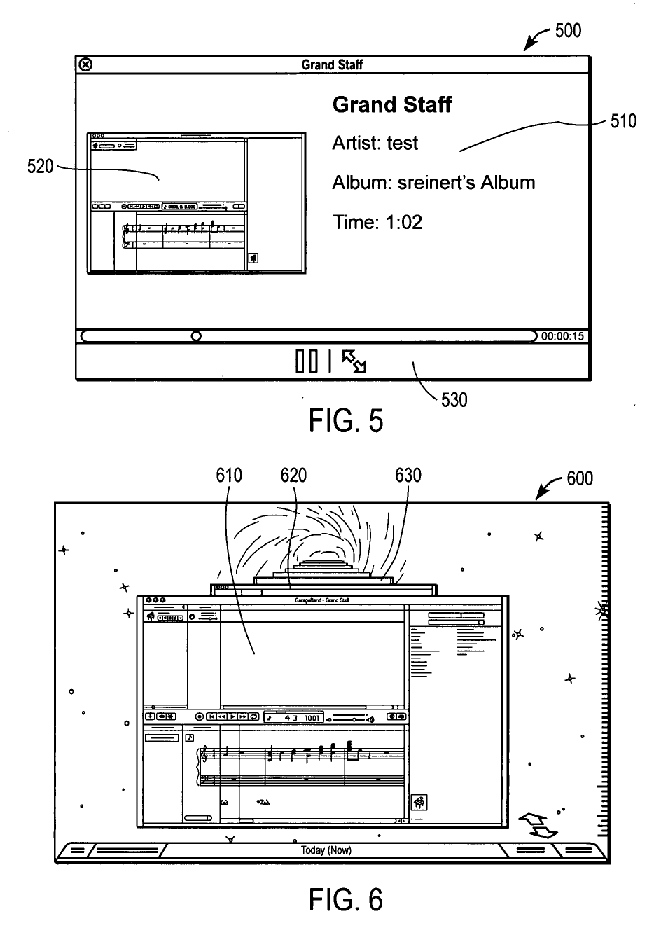

FIG. 5 shows a particular implementation of a preview window 500 for previewing audio data. Such a previewing functionality may be carried out by an application specially designed for previewing which starts up almost instantaneously. The preview window 500 of this implementation features a first preview window section 510 which provides certain information about the audio data that is previewed. In this example, the music project “Grand Staff” is previewed and the first preview window section 510 gives information about the artist's name, the name of the album and the time duration. The information given in this section may be changed by other default settings or by user defined preferences.

A second preview window section 520 shows an image which represents at least a part of an internal structure of the audio data. In this example, the second preview window section 520 shows the screenshot shown in FIG. 4 which may be the content of the image file “arrange_screenshot.tiff”. Accordingly, the user is provided with a graphical impression of the internal structure of the music project he is previewing. Alternatively, the internal structure could also be represented differently, e.g. by showing some or all instruments which are used in the music project. Such an image may consist of a stage showing pictures of certain instruments or musicians or both. The structure and the content of the image shown in the second preview window section 520 may be very different depending on the program used for creating or editing the song or the music project and on the use of the program.

The preview window 500 of this implementation has a third preview window section 530 which allows the user to listen to the content of the audio data. The third preview window section 530 may allow the user to playback part of or the complete song stored in the music project. For this purpose the file “Output.aif” shown in FIG. 3 may be used. Using such a special file designated and prepared for preview, it is not necessary to load the complete content of the music project.

At least in the embodiment described with respect to FIG. 5, the user is able to preview audio data easily and without long delay times. The user is provided with an image representing the internal structure of the music project and he can at the same time listen to the audio content of the music project. This may be achieved using special files for preview like those stored in the folder “Output” shown in FIG. 3.

FIG. 6 shows another embodiment of previewing audio data. A preview browser 600 is provided. The preview browser 600 may be used in the context of a backup system so that multiple versions of a file or project stored at different points in time are displayed. The preview browser 600 may also be used to browse different audio files or music projects or the like. The arrows at the lower right part of the preview browser 600 or some other control means like a keyboard may be used to browse through the previews which are displayed in a stacked manner in FIG. 6.

In an embodiment which uses the preview browser 600 in the context of a backup system, different versions of audio data may be displayed. As an example, a first version 610 may be displayed in the front, a second version 620 and a third version 630 may be stacked behind. Each version is represented by a screenshot so that the user gets an optical impression of the content of the music project version. Accordingly, the user may easily recognize the version he is looking for. The stacked versions may be arranged in a way that older versions are shown behind newer ones or vice versa. The user may give an input so that the second version is moved to the front. In this case, the first version 610 may disappear or may be moved to the other end of the stack. In certain implementations, audio data of the version which is in the front position may be automatically reproduced.

Other implementations are within the scope of the following claims.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine implemented method comprising:
previewing audio data, wherein an image is displayed, as part of the previewing, which represents at least a part of an internal structure of the audio data.

2. The method of claim 1, wherein:
the audio data is part of a project being created by a music program for recording, arranging, mixing, and producing complete music projects, and
the image is stored within a data structure of the project.

3. The method of claim 2, wherein previewing audio data includes that the music program does not need to be loaded for previewing.

4. The method of claim 1, wherein the image is a screenshot or part of a screenshot taken when last saving the audio data.

5. The method of claim 4, wherein the image comprises at least part of an arrange area and/or at least part of a track editor area.

6. The method of claim 1, wherein, while the image is displayed, at least part of the audio data can be reproduced during preview using an audio file designated for preview.

7. The method of claim 1, wherein multiple previews with respective images of the audio data stored at different points in time are displayed in a stacked manner and wherein it is possible to browse through these multiple previews.

8. A program product configured to be executed on a data processing system having a processor and a memory, said program providing for previewing audio data, the program having a program code configured to:
display an image which represents at least a part of an internal structure of the audio data.

9. The program product of claim 8, wherein:
the audio data is part of a project being created by a music program for recording, arranging, mixing, and producing complete music projects, and
the image is stored within a data structure of the project.

10. The program product of claim 9, wherein the program code is adapted so that previewing audio data includes that the music program does not need to be loaded for previewing.

11. The program product of claim 8, wherein the program code is adapted so that the image is a screenshot or part of a screenshot taken when last saving the audio data.

12. The program product of claim 11, wherein the program code is adapted so that the image comprises at least part of an arrange area and/or at least part of a track editor area.

13. The program product of claim 8, wherein the program code is adapted so that, while the image is displayed, at least part of the audio data can be reproduced during preview using an audio file designated for preview.

14. The program product of claim 8, wherein the program code is adapted so that multiple previews with respective images of the audio data stored at different points in time are displayed in a stacked manner and wherein it is possible to browse through these multiple previews.

15. A data processing system having a graphical user interface for enabling a user to preview audio data, comprising:
display means for displaying an image which represents at least a part of an internal structure of the audio data.

16. The data processing system of claim 15, wherein the graphical user interface is adapted so that:
the audio data is part of a project being created by a music program for recording, arranging, mixing, and producing complete music projects, and
the image is stored within a data structure of the project.

17. The data processing system of claim 16, wherein the graphical user interface is adapted so that previewing audio data includes that the music program does not need to be loaded for previewing.

18. The data processing system of claim 15, wherein the graphical user interface is adapted so that the image is a screenshot or part of a screenshot taken when last saving the audio data.

19. The data processing system of claim 18, wherein the graphical user interface is adapted so that the image comprises at least part of an arrange area and/or at least part of a track editor area.

20. The data processing system of claim 15, wherein the graphical user interface is adapted so that, while the image is displayed, at least part of the audio data can be reproduced during preview using an audio file designated for preview.

21. The data processing system of claim 15, wherein the graphical user interface is adapted so that multiple previews with respective images of the audio data stored at different points in time are displayed in a stacked manner and wherein it is possible to browse through these multiple previews.
